(19) United States
(12) Patent Application Publication
(10) Pub. No.: US 2002/0118810 A1
(43) Pub. Date: Aug. 29, 2002

(54) System and method to effect telephone call barge-in without operator intervention

(76) Inventors: Akhtar Akhteruzzaman, Naperville, IL (US); Michael Braker Johannesen, Glen Ellyn, IL (US); Paul R. Sand, Woodridge, IL (US); Richard Grant Sparber, Wheaton, IL (US); Claudis L. Young, Aurora, IL (US)

Correspondence Address: Docket Administrator (Room 3C-512), Lucent Technologies Inc., 600 Mountain Avenue, P.O. Box 636, Murray Hill, NJ, 07974-0636, US

(21) Appl. No.: 09/793,190

(22) Filed: Feb. 26, 2001

(51) Int. Cl. H04M 3/42

(52) U.S. Cl. 379/212.01; 379/207.01

(57) ABSTRACT

A stable telephone call barge-in without operator intervention is described wherein a telephone line is provided with two separate directory numbers. One directory number is the usual directory number associated with the line. The second directory number is considered the priority directory number which also translates in circuit switched telephony as the same line ID. Therefore, when a call is in a stable state, a person dialing the regular directory number will receive a busy signal. The person can then disconnect and dial the priority number. When the priority number is received, advantageously, a password is entered into the system to verify that the user of the priority number has permission to barge in. If the password is valid, the existing call is disconnected and the party barging in is connected to the called party. The other call may be placed on hold or alternatively may be disconnected with or without an announcement.

### FIELD OF THE INVENTION

This invention relates to the field of telephony and, more specifically, to a system and method that permits a user to barge into a currently established telephone call without the intervention of the operator.

### BACKGROUND OF THE INVENTION

In modem telephony, a “busy signal” is becoming more rare and more common at the same time. A telephone line that is used primarily for voice frequently included call waiting, which provides a calling third party with an audible ring signal. The called party may choose to answer or ignore the call waiting signal. If ignored, the called party continues to receive the audible ring signal. On the other hand, lines that are used for modem connections frequently do not have call waiting or disable call waiting when the user causes the modem to dial. These calls frequently have line occupancy times of more than an hour; way above the average voice call of 2 minutes. Thus, a calling party has a better chance to “get through” to the called party on a voice call, but little or no chance on a data call.

Furthermore, a calling party receives a busy signal when a telephone set is off-hook and not connected to a call. Dial-tone is sent over the off-hook line for a predetermined time, followed by a “howler” tone for a further time. The line is then shut down, which precludes anyone getting through (until the phone is placed on switch-hook again). The caller can call the operator to verify the state of the line (operator busy-verify) by bridging onto the line and listening for voice (a scrambler is put on the operator's receiver side for privacy). Further, the operator may barge in on an existing call if the calling party presents a case for such drastic action.

A calling third party receives a busy signal, and, because of the long hold time of some voice and data calls, can receive a busy or audible ring tone for a long period of time. If a person must reach the user of the telephone line, he or she must call the operator to perform either an operator busy verify or, in emergency situations, operator barge in.

With the rise in hold time of stable telephone calls, operator intervention is becoming expensive to the operating companies. In cases where there is one phone line in a residence and a personal computer is connected to the Internet via one telephone line, there is currently no manner to barge in or verify unless there is a dire emergency and the operator is involved.

### SUMMARY OF THE INVENTION

This problem is solved and a technical advance is achieved in the art by a system and method that provides for call barge-in and verify without operator intervention. According to one exemplary embodiment of this invention, a telephone line wherein the user subscribes to this feature is provided with two separate directory numbers. One directory number comprises the normal or “published” directory number associated with the line. The second directory number comprises a “priority” directory number. When a call is in a stable state on the telephone line, a calling party dialing the regular directory number receives a busy signal. The calling party can then disconnect from the busy signal and dial the priority number. When the priority number is received, advantageously, a password is entered to verify that the user of the priority number has permission to barge in. If the password is valid, the extant call is interrupted and the barge-in party is connected to the called party. The other call may be placed on hold, or, alternatively, may be disconnected with or without an announcement.

According to another embodiment of this invention, a party may barge in by dialing a preemption number and password, which may advantageously cause a howler tone to be applied to the called line. The called party then knows to go on-hook, the original call is disconnected and the barge-in call is connected in the usual manner.

According to a third embodiment of this invention, when a calling party receives a busy signal, the party disconnects and dials an 800 number. The calling party is then prompted for the destination directory number and a password. Call processing then proceeds according to one of the previous embodiments.

### BRIEF DESCRIPTION OF THE DRAWINGS

A more complete understanding of the invention may be obtained from a consideration of the following description taken in conjunction with the drawings in which:

FIG. 1 is a block diagram of a telephone network in which several embodiments of the current invention may be implemented;

FIG. 2 is a flowchart of a first embodiment of this invention which may be implemented in the telecommunications system of FIG. 1;

FIG. 3 is a second embodiment of the current invention which may be implemented in the telecommunications system of FIG. 1; and

FIG. 4 is a flowchart of a third embodiment of the current invention which may be implemented in the telecommunications system of FIG. 1.

### DETAILED DESCRIPTION

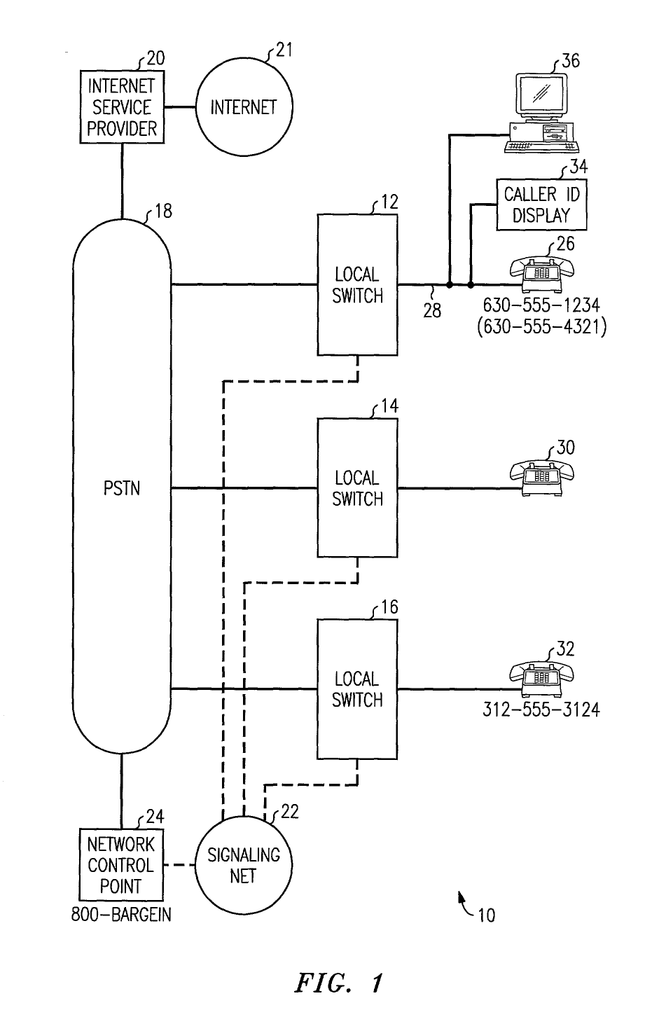

Turning now to FIG. 1, a block diagram of a telephone network 10, in which several embodiments of the current invention may be implemented, is illustrated. Telephone network comprises a plurality of local telephone switching systems (“local switches”) represented by local switches 12, 14 and 16. All local switches are connected to the public switched telephone network (PSTN) 18. An Internet service provider (ISP) 20 is also connected to PSTN 18 and to the Internet 21. Further, each local switch 12, 14, and 16 is connected to a signaling network 22. Signaling network 22 comprises, for example, Signaling System 7 (SS7) network as is well known in the art. A network control point 24 is connected to signaling network 22.

In order to explain the exemplary embodiments of this invention, three telephones are illustrated connected to telephone network 10. Telephone 26 is connected to local switch 12 by line 28 and has a telephone number (directory number or DN) of 630-555-1234. Telephone 30 is connected to local switch 14. Telephone 32 is connected to local switch 16 and has an exemplary DN of 312-555-3124. To complete the description of the exemplary embodiment, caller ID display 34 and personal computer (PC) are also connected to line 28, as is known in the art.

The general principles of this invention are illustrated in telephone network 10 in which telephone 26 subscribes to a feature for telephone call barge-in without operator intervention. For purposes of explaining this invention, users of telephone 26 and 30 are engaged in a telephone call. The user of telephone 32 (“calling party”) wishes to contact the user of telephone 26 (“called party”). The calling party dials the normal DN (630-555-1234) of telephone 26, the call is routed through local switch 16, PSTN 18, and local switch 12 as is known in the art. Local switch 12 checks the status of line 28 and reports that line 28 is busy. This busy state is reported back to local switch 16 which provides a busy signal to the calling party. According to the prior art, if telephone 26 does not subscribe to call waiting or, alternatively, chooses to ignore call waiting, the user of telephone 32 has only the option of calling the operator and asking for intervention.

According to this invention, the user of telephone 32 may dial a special directory number, 630-555-4321 in this exemplary embodiment, associated with telephone line 28. When this number is dialed, a call is set up between local switch 16 and local switch 12 according to the prior art. However, instead of reporting busy signal back to local switch 16, the established call is disconnected. The connection to telephone 30 is disconnected by putting the connection on hold or dropping the call. Advantageously, an announcement may be made from local switch 12 and a message displayed on caller I) display 34 of the calling telephone number (312-555-3124) that the special directory number has been dialed, giving the called party an opportunity to either disconnect the call to telephone 30 or alternatively put the interrupted call on hold.

For purposes of explaining an alternative embodiment of this invention, PC 36 is connected to the Internet 21 via ISP 20. The calling party at telephone 32 receives a busy signal when trying to call telephone 26 on its DN (630-555-1234) for the duration of the PC connection. The user then dials an 800 telephone number, for example 1-800-BARGEIN. Local switch 16 sends a message through signaling network 22 to a network control point 24 to determine instructions for setting up a call when this number is dialed, as is known in the art. Network control point 24 prompts the user of telephone 32 for the desired telephone to be barged into, (i.e., 630-555-1234 for telephone 26) and advantageously a PIN or a password. The signaling network then causes the call between telephone 26 and ISP 20 to be suspended or dropped and a call completed between local switch 16 and local switch 12 through PSTN 18 according to normal practice. In this manner, a user may barge into a home phone or alternatively to someone else's phone provided they have enough information (preferably including a password or a PIN). This is quite useful in today's lengthening hold times and would be most useful in cases where the user of telephone 26 is connected to an Internet service provider 20. Optionally, a determination may be made whether modem signaling is present on the line. If it is, a disconnect signal may be sent in both directions, clearing the line for the barge-in call.

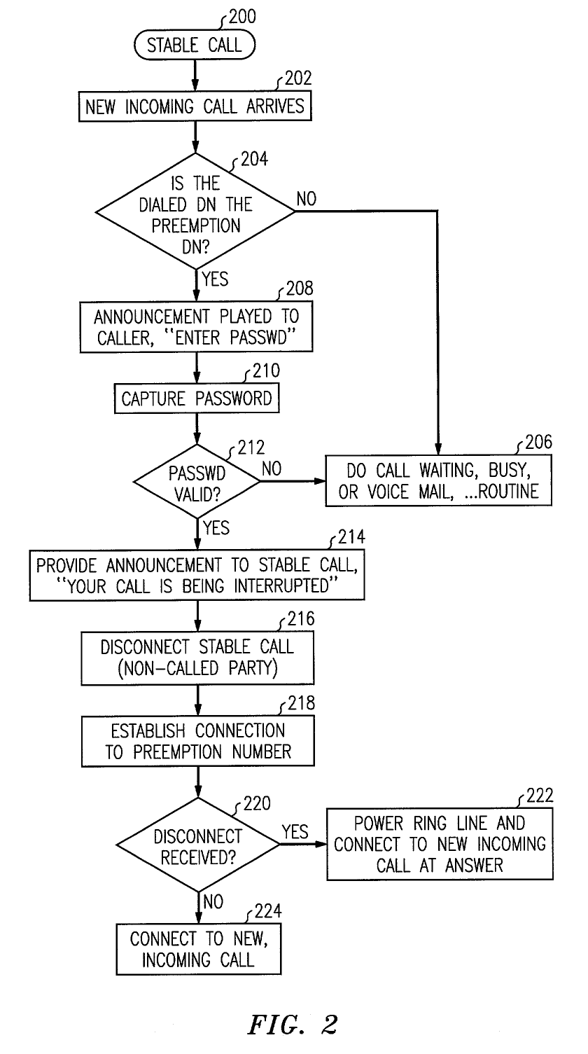

FIG. 2 is a flow diagram of actions taken in local switch 12 to provide the feature of telephone call barge-in without operator intervention. In FIG. 2, a stable call, for example between telephone 26 and 30, is established in box 200. In action box 202, a new incoming call arrives from for example telephone 32. A determination is made in decision diamond 204 whether the dialed number is the preemption DN number (630-555-4321). If the dialed number is not the preemption number then the normal call treatment for that particular telephone, i.e., call waiting, busy, voice mail routine as is known in the art is performed in action box 206.

If, in decision diamond 204, the dialed DN is the preemption DN an announcement is played to the caller to enter a password or PIN in action box 208. The PIN is captured in action box 210 and a determination is made in decision diamond 212 whether the PIN or password is valid. If the password is not valid, then call waiting, voice mail, etc. is performed in action box 206.

If the password is valid then processing moves to action box 214 where an announcement is provided to the stable call (both front party and back party). For example, “Your call is being interrupted” or alternative a tone or some other method is shown and/or a caller ID display 34 is alerted. Processing moves to action box 216 where the stable call is disconnected; that is, the connection to telephone 30 is ended.

A call is then connected between telephone 30 and telephone 26 in action box 218. Processing waits until disconnect is received in decision diamond 220. If disconnect is received, i.e., the user of telephone 26 put the receiver on hook, then power ring is applied to the line and the call is connected to telephone 30 in action box 222. If disconnect is not received within a predetermined time, the call is automatically connected in action box 224.

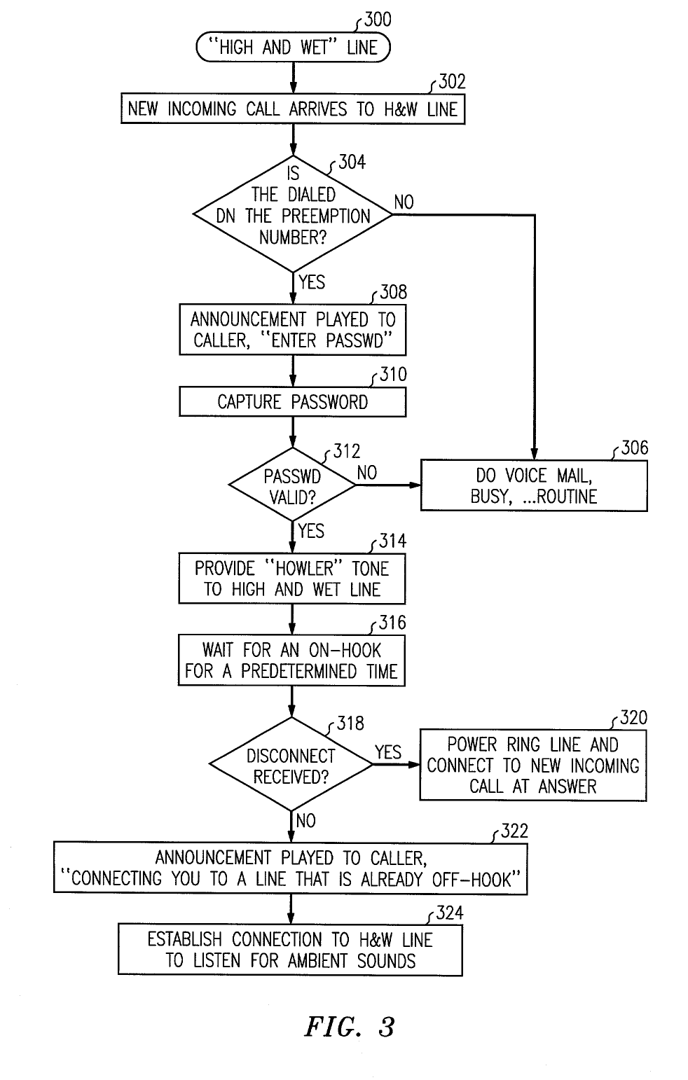

Turning now to FIG. 3, another exemplary embodiment of this invention is shown. This embodiment of this invention takes place in local switch 12. In the flowchart of FIG. 3, line 28 is a “high and wet” line, meaning line 28 to telephone 26 is off-hook but not connected to any party. Processing moves to action box 302 where a new incoming call arrives for the high and wet line 28. A determination is made in decision diamond 304 if the dialed number is the preemption number (630-555-4321). If not, processing continues to action box 306 where normal line busy activity is performed for that particular subscriber (i.e., voice mail, busy, call waiting, call waiting with caller ID, etc.) If, in decision diamond 304, the dialed DN is the preemption number then processing moves to action box 308 where an announcement is played to the caller to enter a password or PIN. Processing moves to action box 310 where the PIN is captured and then to decision diamond 312 where a determination is made if the password is valid. If the password is not valid, then the normal line busy treatment is performed in action box 306.

If, in decision diamond 312, the password is valid then processing moves to action box 314 where, for example, a howler tone as is known in the art is provided to the line to telephone 26. Other forms of interruption such as a call waiting tone or call waiting on caller ID is displayed on 34 may also be provided. The local switch 12 then waits for an on-hook from telephone 26 for a predetermined time period.

A determination is made in decision diamond 318 to determine whether an on-hook was received. If an on-hook was received, then processing proceeds to action box 320 where power ring is applied to the line and the call is connected to telephone 32 through telephone network 10.

If on-hook is not received within a predetermined period of time it is determined in decision diamond 318 that an announcement is played to the caller. Processing proceeds to action box 322 where an announcement is played to the caller that the call is being connected to a line that is already off hook. A call is then established from telephone 26 to telephone 32 in action box 324. This embodiment is useful to replace operator busy-verify.

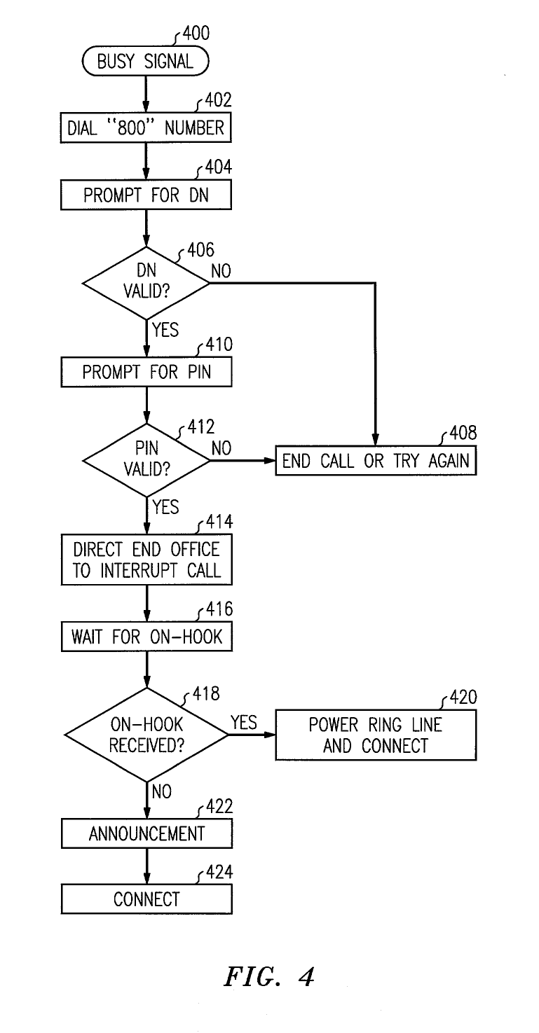

Turning now to FIG. 4, another alternative embodiment of the present invention is shown. In this embodiment, the user of telephone 32 receives a busy signal in the action box 400. The user of telephone 32 hangs up and then dials an 800 number in action box 402. The 800 number is routed from local switch through PSTN and signaling network to network control point 24. Network control point 24 then prompts the user of telephone 32 for the DN which is calling for barge-in service. In decision diamond 406, a determination can be made whether the desired DN has permission to use the service and whether the DN is valid. If the DN is not valid, then the call may be ended or the caller may be prompted to try again in action box 408.

If the DN is valid in decision diamond 406, then the user is prompted by network control point 24 for a PIN or password in action box 410. The PIN or password is then validated in decision diamond 412. If the PIN or password is not valid, then the call may be ended or the user prompted to try again in action box 408.

If the PIN is valid in decision diamond 412, then network control point 24 directs the end office (local switch 12) to interrupt the call. The call interrupt may be a howler tone as described above, a voice interrupt or other tone as is known in the art. In action box 416, the network control point 24 waits for an on-hook signal back from telephone 26. If an on-hook is received as determined by decision diamond 18, then power ring is applied to line for telephone 26 and the call is connected from telephone 30 through telephone 26. Network control point 28 then drops off the call. If on-hook is not received in decision diamond 418, then an announcement is made in 422 that the caller is being connected to a line that is off hook and in action box 424 the call is connected.

It is to be understood that the above-described invention embodiments are merely aspects of the invention and that many variations may be made by those skilled in the art. For example, the call that is barging in may be bridged onto the line as a third party. It is, therefore, intended that such variations be included within the scope of the following claims.

What is claimed is:

1. A method for providing barge in to a telephone call between a first telephone and a second telephone by a third telephone, without operator intervention, comprising the steps of:
providing a barge in telephone number for said first telephone;
disconnecting said second telephone from said first telephone upon recognition that said barge in telephone number was dialed; and
connecting said second telephone to said third telephone.

2. A method in accordance with claim 1 further including the step of:
dialing a personal identification number after said step of dialing said barge in telephone number.

3. A method in accordance with claim 1 wherein the step of disconnecting said second telephone from said first telephone comprises putting said first telephone on hold.

4. A method in accordance with claim 1 wherein the step of disconnecting said second telephone from said first telephone comprises sending an on hook signal to said second telephone.

5. A method in accordance with claim 1 further including the step of applying a tone to said first telephone before said step of disconnecting.

6. A method in accordance with claim 5 further including the step of waiting for an on hook signal from said first telephone before said step of disconnecting, and, if said on hook signal is received, applying ringing to said first telephone.

7. A method in accordance with claim 5 wherein said tone comprises a howler tone.

8. A telephone switching apparatus that provides a feature of call barge in without operator intervention comprising:
means for recognizing a barge in request from a first party has been made for a telephone number;
means for connecting a call between said first party and said telephone associated with said barge in telephone number.

9. A telephone switching apparatus according to claim 8 wherein said switching system includes a tone generator and said switching system is further configured to apply a tone from said tone generator to said telephone associated with said barge in telephone number responsive to said means for receiving a call to a barge in telephone number receiving a call.

10. A telephone switching apparatus according to claim 8 further including means for prompting for, receiving and verifying a personal identification number prior to barging into an existing telephone call.

11. A telephone switching apparatus according to claim 8 wherein said telephone associated with said barge in telephone number includes a caller ID device, and wherein said telephone switching apparatus includes means for displaying on said caller ID device an indication of a pending barge in call.

12. A method for operating a telephone network to provide barge in without operator intervention, said telephone network comprising a plurality of local switching systems and a first, a second and a third telephone connected to a switching system in said network, said method comprising:
determining that said first telephone and second telephone are in a stable call responsive to said third telephone calling said first telephone;
dialing a second number for said first telephone at said third telephone;
disconnecting said call between said first and second telephones; and
connecting said first telephone and said third telephone.

13. A method in accordance with claim 12 wherein said second number for said first telephone comprises a standard directory number.

14. A method in accordance with claim 12 wherein said second number for said first telephone comprises a common number, and wherein said method further comprises:
entering the directory number of said first telephone;
causing said disconnecting of said first and second telephones; and
causing said connecting of said first and third telephones.

15. A method in accordance with claim 12 further including the step of entering a personal identification number after entering the directory number of said first telephone.
